(19) United States
(12) Patent Application Publication
(10) Pub. No.: US 2025/0209370 A1
(43) Pub. Date: Jun. 26, 2025

(54) METHOD AND SYSTEM FOR ENHANCING MACHINE LEARNING MODEL PERFORMANCE THROUGH DATA REWEIGHTING

(71) Applicant: FAIR ISAAC CORPORATION, Minneapolis, MN (US)

(72) Inventors: Gerald Fahner, Austin, TX (US); Christopher Allan Ralph, Toronto (CA)

(21) Appl. No.: 18/391,171

(22) Filed: Dec. 20, 2023

(51) Int. Cl. G06N 20/00

(52) U.S. Cl. CPC G06N 20/00

(57) ABSTRACT

A computer-implemented method includes maintaining a historical data sample comprising a plurality of observation records, each observation record comprising a set of predictive features, a set of dependent variables, and a baseline weight variable; generating a target distribution for the plurality of observation records, wherein the target distribution comprises a first plurality of target percentages for a subset of the predictive features and a second plurality of target percentages for a subset of the dependent variables, generating a reweight variable for each observation record based at least in part on the target distribution and the baseline weight variable, wherein the reweight variable comprises optimized weights for each of the predictive features and each of the dependent variables, and generating a reweighted data sample by replacing the baseline weight variable in each observation record of the historical data sample with a corresponding reweight variable.

### TECHNICAL FIELD

The subject matter described herein relates to systems and methods for improving the performance of supervised machine learning models, and for providing accurate assessment of model performance by pre-processing assessment data.

### BACKGROUND

Machine learning models are widely used in various fields, including finance, healthcare, and technology, to make predictions or decisions based on input data. These models may be trained on historical data to predict future outcomes. However, when future conditions differ significantly from the past, model performance can degrade. Traditional methods of model assessment using historical data may not accurately predict future performance, leading to a gap between expected and actual model efficacy. There is a recognized challenge in adapting models to account for changes in data distributions over time, which can be due to evolving trends, disruptive events, or different operational environments. There exists a need to develop machine learning models that account for the discrepancies in data distribution and applied conditions between historical data and current or potential future situations.

### SUMMARY

Methods, systems, and articles of manufacture, including computer program products, are provided for improving model performance in machine learning systems. In one aspect, there is provided a system. The system may include at least one processor and at least one memory. The at least one memory may store instructions that result in operations when executed by the at least one processor. The operations may include: maintaining a historical data sample comprising a plurality of observation records, each observation record comprising a set of predictive features, a set of dependent variables, and a baseline weight variable; binning the plurality of observation records across the set of predictive features and the set of dependent variables to generate predictive feature bins and dependent variable bins, generating a target distribution for the plurality of observation records, wherein the target distribution comprises a first plurality of target bin percentages for a subset of the predictive feature bins and a second plurality of target bin percentages for a subset of the dependent variable bins; generating a reweight variable for each of the observation records based at least in part on the target distribution and the baseline weight variable, and generating a reweighted data sample by replacing the baseline weight variable in each observation record of the historical data sample with a corresponding reweight variable.

In another aspect, there is provided a method. The method includes: maintaining a historical data sample comprising a plurality of observation records, each observation record comprising a set of predictive features, a set of dependent variables, and a baseline weight variable; binning the plurality of observation records across the set of predictive features and the set of dependent variables to generate predictive feature bins and dependent variable bins, generating a target distribution for the plurality of observation records, wherein the target distribution comprises a first plurality of target bin percentages for a subset of the predictive feature bins and a second plurality of target bin percentages for a subset of the dependent variable bins; generating a reweight variable for each of the observation records based at least in part on the target distribution and the baseline weight variable, and generating a reweighted data sample by replacing the baseline weight variable in each observation record of the historical data sample with a corresponding reweight variable.

In another aspect, there is provided a computer program product including a non-transitory computer readable medium storing instructions. The operations include maintaining a historical data sample comprising a plurality of observation records, each observation record comprising a set of predictive features, a set of dependent variables, and a baseline weight variable; binning the plurality of observation records across the set of predictive features and the set of dependent variables to generate predictive feature bins and dependent variable bins, generating a target distribution for the plurality of observation records, wherein the target distribution comprises a first plurality of target bin percentages for a subset of the predictive feature bins and a second plurality of target bin percentages for a subset of the dependent variable bins; generating a reweight variable for each of the observation records based at least in part on the target distribution and the baseline weight variable, and generating a reweighted data sample by replacing the baseline weight variable in each observation record of the historical data sample with a corresponding reweight variable.

Implementations of the current subject matter can include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating a schematic representation of an exemplary architecture in which a historical data sample is processed into an optimized data sample, according to one or more embodiments consistent with the current subject matter;

FIG. 2 is a process flow diagram illustrating a process for the platform and systems provided herein to improve model performance in machine learning systems, according to one or more implementations of the current subject matter.

FIG. 3 is a process flow diagram illustrating a process for the platform and systems provided herein to form an optimization problem for generating optimized weights in machine learning systems, according to one or more implementations of the current subject matter.

FIG. 4 depicts a block diagram illustrating an example of a computing system, consistent with implementations of the current subject matter; and

When practical, like labels are used to refer to same or similar items in the drawings.

### DETAILED DESCRIPTION

The details of one or more variations of the subject matter described herein are set forth in the accompanying drawings.

As discussed herein elsewhere, the problem of historical data not accurately representing future conditions may exist. Therefore, there provides methods and systems that may reweight historical data to simulate future-like conditions, enabling the development and assessment of machine learning models that are more predictive and robust when deployed in changing environments. For example, these methods and systems may leverage knowledge extracted from various sources to design target distributions that may reflect anticipated future scenarios, whether they be gradual market trends, economic shifts, or demographic changes, or a data distribution designed by an attacker with malicious goals. By incorporating a reweighting mechanism, the historical data can be adjusted to create a more representative sample of future conditions. This reweighting not just enhances the predictive accuracy of models but also provides a more realistic assessment of their potential performance in future operational settings. The systems and methods may thus further facilitate a proactive approach to model development and validation, allowing for the anticipation of future challenges and the mitigation of risks associated with model deployment in dynamic environments.

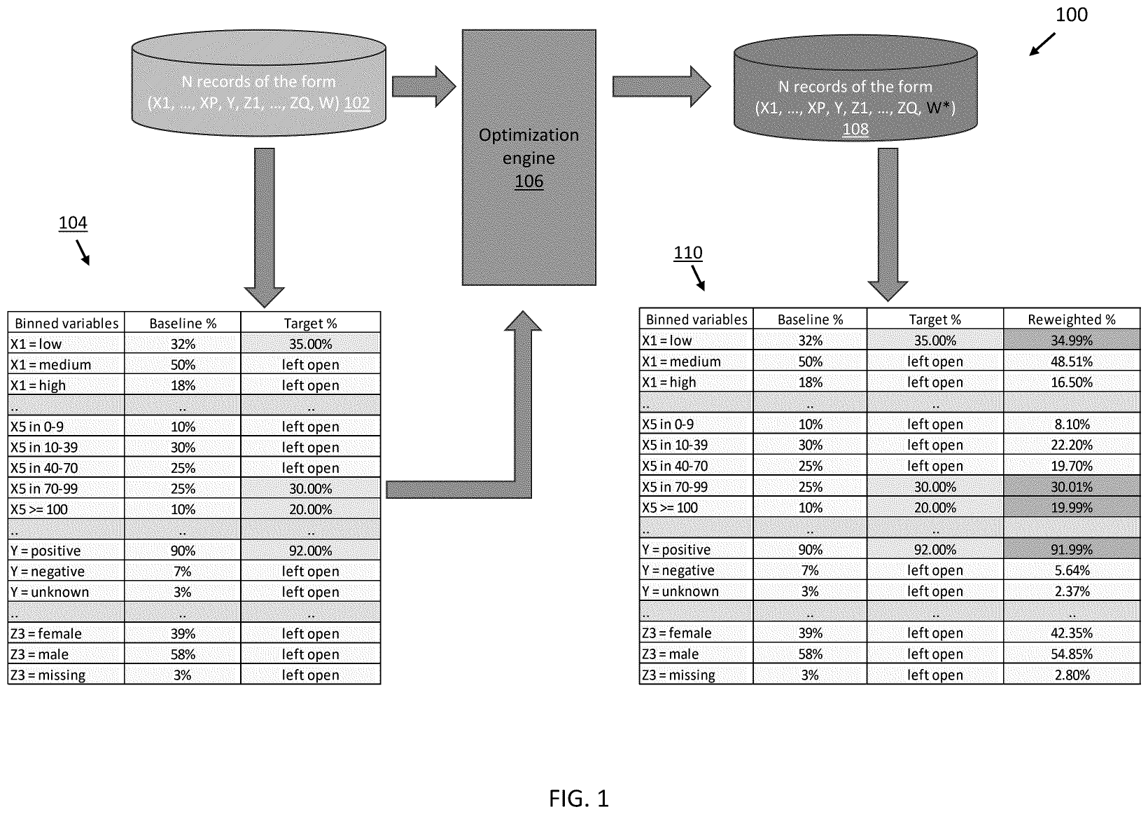

FIG. 1 is a diagram illustrating a schematic representation of an exemplary architecture 100 in which a historical data sample is processed into an optimized data sample, according to one or more embodiments consistent with the current subject matter. As shown in FIG. 1, historical data sample 102 may be stored in a database. In some embodiments, the historical data sample 102 may comprise a plurality of observation records, wherein each observation record may comprise a set of predictive features X1, . . . , XP; a set of dependent variables Y, and a baseline weight variable W. The predictive features X1, . . . , XP may be a diverse set of variables selected based on their relevance to the outcome being modeled. For example, these predictive features could include demographic information, economic indicators, behavioral patterns, transactional data, sensor readings, or any other quantifiable metrics that contribute to the predictive scheme of the model. The selection and utilization of these features may be guided by domain knowledge and/or the specific context of the application. The dependent variables Y are the outcomes that the supervised machine learning model aims to predict or estimate. In some embodiments, the dependent variables Y may be labels associated with training samples. These dependent variables Y may represent a wide array of possible outputs, such as the likelihood of a customer making a purchase, the probability of a patient developing a specific health condition, the expected revenue from a sales campaign, or the risk score associated with a financial transaction. In classification tasks, the dependent variable may be categorical, indicating membership in a particular class or category. In regression tasks, the dependent variable may be continuous, representing a quantity or a level. In some embodiments, the baseline weight variable W may be a numerical value associated with each observation record in the historical data sample. In some embodiments, the weight may represent the relative importance or frequency of the observation in the dataset. For instance, if the historical data is a sample from a larger population, the baseline weight W could adjust for over- or under-representation of particular observations to better reflect the true population distribution. In cases where no specific weighting is initially provided or applicable, the baseline weight W may be set to a default value, such as 1, indicating equal weight for all observation records. The baseline weight variable may serve as the starting point for optimization when recalibrating the data to simulate future-like conditions. In some embodiments, the observation records may also comprise Q number of other variables, for example, non-predictive variables. In some embodiments, these non-predictive variables may be denoted by Z1, . . . , ZQ. In some embodiments, these Q variables may not be used by the model.

As shown in FIG. 1, the historical data sample 102 may be binned over the predictive features and the variables. The corresponding bin percentages may be calculated for each of the predictive features and the variables. As shown in the table 104, the baseline percentage for each of the binned variable may be counted, and may be logged in the table 104. For each individual predictive feature or variable, a sum of the baseline percentage may equal to 1 (or 100%).

In some embodiments, a target distribution may be generated. In some embodiments, a target distribution comprising a target percentage for some of the predictive features or variables may be generated, as shown in table 104 of FIG. 1. In some embodiments, the target percentage may represent a desired proportional representation of specific bins or categories within the predictive features, dependent variables, or other variables of interest in the reweighted data sample. In some embodiments, these target percentages may be specified by the user or domain expert and reflect the expected or desired distribution of the data under future operating conditions. In some embodiments, the target percentages may be used during the optimization process to adjust the observation weights in such a way that the distribution of the reweighted data sample aligns with these future-like conditions as closely as possible, within a pre-defined tolerance. Additionally, during the optimization process, the observation weights is also adjusted in a way that the reweighted data set approximates the baseline sample weight, so that the integrity of the baseline data structure is maintained while still reflecting the anticipated future conditions. This may allow for the creation of a data sample that is more representative of anticipated changes or scenarios, which can be used for more accurate model assessment or to train a more robust and future-ready machine learning model. As shown in FIG. 1, the target percentage for a situation where X1 is low is set at 35%, in contrast to the baseline percentage which is 32%. Additionally, as shown in FIG. 1, the target percentage for a situation where X5 is within the range of 70-99 is set at 30%, in contrast to the baseline percentage which is 25%. In some embodiments, these target percentages may be established based on an anticipation of future situations. In other embodiments, these target percentages may be set based on shifts in demographic distribution, which are considered for new predictions utilizing the model. In some embodiments, some of the target percentage for the predictive features and the variables may be left open, so to allow the optimization engine 106 to determine their values. This approach can be particularly useful when the expectations for how these features or variables will be distributed in the future is uncertain or unknown. By leaving some target percentages open, the optimization process can adjust these unspecified bins in a manner that is coherent and consistent with the specified target percentages for other bins. This flexibility enables the optimization engine to maintain the overall structure and relationships within the data while still aligning the reweighted sample with the known or anticipated future conditions. The resulting reweighted data sample can then provide a more realistic and comprehensive assessment of a pre-existing model's potential future performance or aid in the development of a new model that is robust to future uncertainties.

In some embodiments, the table 104, including the target distribution, may be fed to an optimization engine 106. Additionally, the historical data sample may also be fed to the optimization engine 106. The optimization engine 106 may utilize the target distribution and the historical data sample to generate a reweight variable (i.e., new observation weights). This may be achieved by solving an optimization problem that aims to minimize the difference between the achieved distribution of the reweighted data and the desired target distribution, subject to constraints such as non-negativity of weights and their sum equating to one. In some embodiments, the optimization engine 106 may employ various algorithms and techniques, such as Least Squares optimization with regularization, to ensure that the reweighted data sample may be representative of the future-like conditions specified by the target distribution. The output of the optimization engine may be a set of optimized weights (e.g., optimized weights W* of output data 108) for each observation record, which can then be used to generate a reweighted data sample for further analysis or model training. In some embodiments, the output data 108 may be generated by replacing the baseline weight variable in each observation record of the historical data sample with a corresponding reweight variable. In some embodiments, a table 110 may be generated, wherein the reweighed percentage of the binned predict features and the variables may be presented. In some embodiments, the reweighted data may match all the pre-defined target percentage within a tolerance. This may involve the optimization engine applying constraints to ensure that the reweighted percentages for the specified bins do not deviate from the target percentages by more than the pre-defined tolerance level. The tolerance parameter provides a buffer that allows for slight variations while still ensuring that the reweighted data closely aligns with the desired future-like distribution. This capability is particularly useful for accommodating uncertainties in the predictions about future conditions or for allowing some degree of flexibility in scenarios where exact target percentages are not strictly enforceable or known. The tolerance levels can be adjusted based on the level of precision or robustness desired in the reweighted data sample, thus enabling a balance between accuracy and practicality in the model assessment or development process.

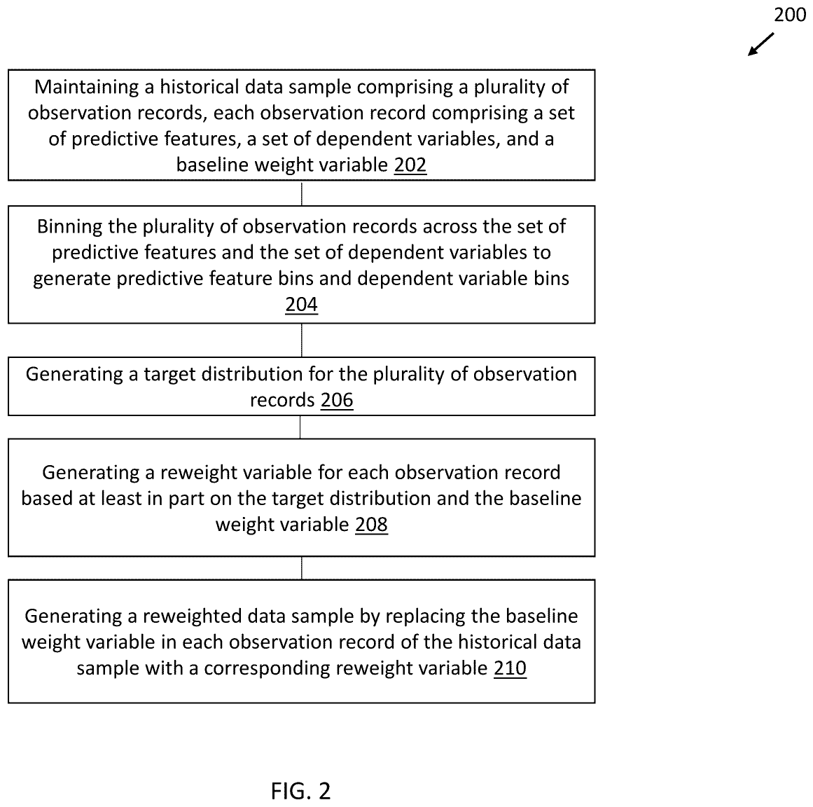

FIG. 2 is a process flow diagram illustrating a process 200 for the platform and systems provided herein to improve model performance in machine learning systems, according to one or more implementations of the current subject matter. As shown in FIG. 2, the process 200 may begin with operation 202, wherein the system may maintain a historical data sample comprising a plurality of observation records, each observation record comprising a set of predictive features, a set of dependent variables, a baseline weight variable. In some embodiments, the observation record may further comprise a set of other, non-predictive variables, for example the variables Z1, . . . , ZQ as describe herein elsewhere.

In some embodiments, the process 200 may continue with operation 204, where the system may analyze the historical data sample and bin the observation records across the set of predictive features and the set of dependent variables to generate predictive feature bins and dependent variable bins. In some embodiments, each bin of the predictive feature bins and the dependent variable bins is associated with a baseline bin percentage. In some embodiments, a set of non-predictive variables Z may also be binned and each of these bins is associated with an baseline bin percentage.

Next, in operation 206, a target distribution for each of the plurality of observation records may be generated. In some embodiments, the target distribution comprises a first plurality of target bin percentages for a subset of the predictive feature bins and a second plurality of target bin percentages for a subset of the dependent variable bins. In some embodiment, the difference between the baseline bin percentage and the target bin percentage may be indicative of a change in the data sample that reflects a shift in underlying distribution of the corresponding predictive features or dependent variables to align with targeted operating conditions or expected data distributions. For example, if the historical data sample includes consumer spending habits in a particular region during a period of economic growth, the baseline bin percentages might show a higher frequency of large transactions. However, if the model is to be deployed during an anticipated economic downturn, the target bin percentages for the predictive feature bins related to transaction size would be adjusted to reflect an expected increase in smaller transactions and a decrease in larger ones. Similarly, for a dependent variable such as frequency of transactions, the target bin percentages might be adjusted to reflect an expected decrease in overall transaction frequency due to tighter consumer budgets. This shift in the target distribution would allow the model to be trained or assessed on data that more closely represents the anticipated future economic conditions, rather than the past conditions under which the baseline data was collected. In some embodiments, target bin percentages for the non-predictive variables Z may be generated. For example, the target distribution may include, in addition to the first plurality of target bin percentages for the subset of the predictive feature bins and the second plurality of target bin percentages for a subset of the dependent variable bins, a third plurality of target bin percentages for a subset of the non-predictive variables Z.

Next, in operation 208, the system may generate a reweight variable (i.e. a reweighting of each observation record) based at least in part on the target distribution and the baseline weight variable. In some embodiments, the system may generate the reweight variable based on the target bin percentages for the predictive feature bins, the target bin percentages for the dependent variables, the baseline bin percentages for the predictive feature bins, and the baseline bin percentages for the dependent variables. The reweight variable comprises an optimized weight for each observation, such that the resultant bin percentages of the predictive feature bins and the dependent variable bins approximate (within a pre-defined tolerance) their corresponding target bin percentages, wherein the resultant bin percentages are calculated using the reweighted observations. In some embodiments, the system may generate the reweight variable based further on the target bin percentages for the non-predictive variables Z, in addition to or as alternative to the target bin percentages for the predictive feature bins, the target bin percentages for the dependent variables, the baseline bin percentages for the predictive feature bins, and the baseline bin percentages for the dependent variables. In some embodiments, the reweight variable comprises an optimized weight for each observation, such that the resultant bin percentages of the predictive feature bins, the dependent variable bins, and/or the non-predictive variables Z approximate (within a pre-defined tolerance) their corresponding target bin percentages.

The process 200 may then proceed to operation 210, where the system generates a reweighted data sample by replacing the baseline weight variable in each observation record of the historical data sample with a corresponding reweight variable.

In some embodiments, the reweighted data sample may be fed to a classifier, and the classifier may be trained by the reweighted data sample. Alternatively or additionally, the system may assess the performance of a pre-existing machine learning model by the reweighted data sample. In some implementations, generating the reweight variable may include optimizing an objective function by minimizing a difference between the reweight variable and the baseline weight variable. In some embodiments, the optimizing of the objective function may be conditioned on a deviation between the target bin percentages and the achieved bin percentages not exceeding a pre-defined tolerance. In some embodiments, the optimizing the objective function may further comprise minimizing the difference between an achieved distribution of the reweighted data set and the target distribution. In some embodiments, this may be achieved by minimizing the deviations between the target bin percentages and the achieved corresponding bin percentages in the reweighted data sample. The objective function may be a Least Squares problem, and may comprise inequality constraints associated with each target bin percentage. In some embodiments, inequality constraints may be restrictions in an optimization problem that limit the permissible range of values for the variables.

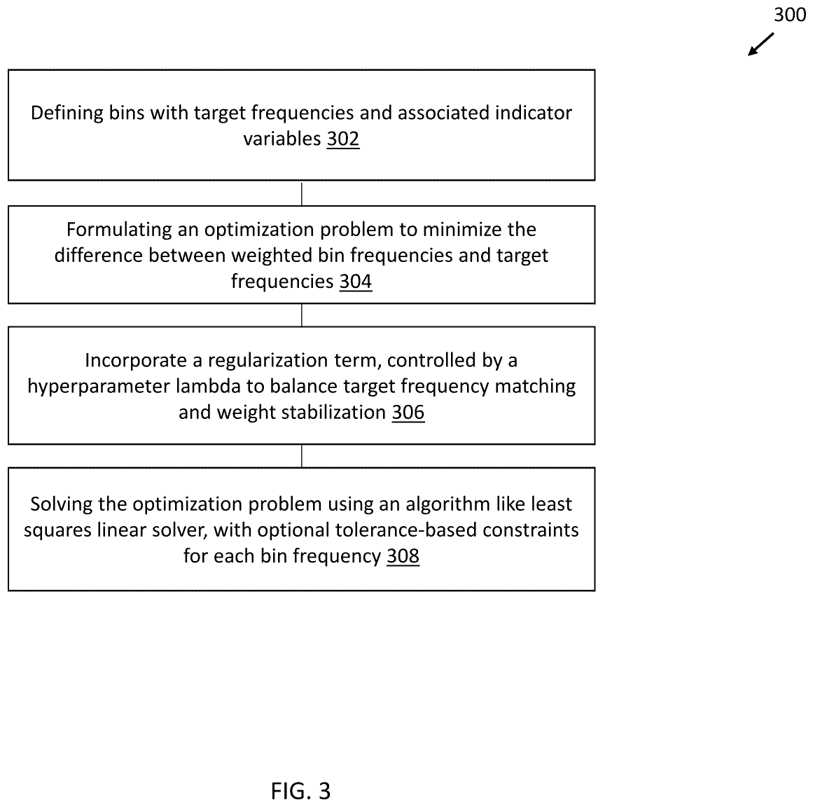

FIG. 3 is a process flow diagram illustrating a process 300 for the platform and systems provided herein to form an optimization problem for generating optimized weights in machine learning systems, according to one or more implementations of the current subject matter. As shown in FIG. 3, the process 300 may begin at operation 302, wherein the system may define bins with target frequencies and associated indicator variables. Next, in operation 304, the system may formulate an optimization problem to minimize the difference between baseline bin frequencies and target frequencies, subject to sum and non-negativity constraints on weights. In some embodiments, the process 300 may proceed to operation 306, wherein the system may incorporate a regularization term, controlled by a hyperparameter lambda to balance target frequency matching and weight stabilization. In operation 308, the system may solve the optimization problem using an algorithm like least squares linear solver, with optional tolerance-based constraints for each bin frequency. For example, the system may formulate the optimization problem so to generate optimal observation weights. In some embodiment, let j=1, . . . , J, and j may enumerate the bins for which there are specified desired Target bin frequencies d1, . . . , dJ. In some embodiment, the desired Target bin frequencies d1, . . . , dJ may be provided by a user. In some embodiments, as shown in FIG. 1, J=4 bins with associated targets bin frequencies enumerated as (d1, . . . , dJ)=(0.35, 0.3, 0.2, 0.92) may be generated. In some embodiments, let Z1, . . . , ZJ be the associated bin indicator variables which were generated for the baseline data. Let N be the number of baseline data observations, and let w=(w1, . . . , wN)′ be the associated observation weights that are to be optimized. These variables are decision variables for the optimization problem. In some embodiments, w is constrained such that sum (w)=1. The observation weighted bin frequencies for the baseline data are then defined:

$${f}_{j} = {\sum }_{i = 1}^{N} {Z}_{{ij}^{W} i} ; j = 1 , … , J$$

wherein Zᵢⱼ is the value of the j'th bin indicator variable for the i'th observation.

The main objective is to obtain bin frequencies fⱼ that are close to the desired dⱼ. This may be achieved by minimizing the squared distance:

$${min}_{w} {\sum }_{j = 1}^{J} {( {f}_{j} - {d}_{j} )}^{2} = {min}_{w} {\sum }_{j = 1}^{J} {( {\sum }_{i = 1}^{N} {Z}_{{ij}^{W} i} - {d}_{j} )}^{2}$$

This is a Least Squares problem of the form (min over w) norm(C*w−d) with the 2-norm (Euclidian length), whereby C is the transposed (J×N) matrix (J rows, N columns) of indicator matrix Z, w is the (N×1) (column) vector of observation weights as defined earlier, and d is the (J×1) (column) vector of desired bin frequencies. In some embodiments, nonnegativity constraints may be imposed on the w. To solve this problem, call:

$${W}^{*} = lsqlin ( C , d , A , b , Aeq , beq ) ;$$

A, b encode the N nonnegativity constraints, and Aeq, beq encode the sum(w)=1 constraint.

In some embodiment, particularly in practical applications where N far exceeds J, having many excess degrees of freedom for optimization might yield solutions that are unstable against small data changes and difficult to interpret. To enhance robustness and interpretability, a regularization term may be added to the objective function, designed to keep the observation weights close to the baseline sample weights (after also normalizing the w to add up to 1.) A tradeoff is expected between the desire to closely match the desired bin frequencies and to keep the w close to the normalized sample weights. In some embodiment, the tradeoff is monitored and controlled by weighing the two objective terms with hyperparameter ‘lambda’>0 to yield robust and credible results. To implement this regularization, the system may augment C and d with N additional rows for w and a diagonal matrix. The large sparse matrices are advantageously encoded as sparse data types.

$$d\_N = [ lambda * d ; sw ] ;$$

$$C\_N = [ lambda * C ; speye ( N ) ] ;$$

before calling lsqlin( ).

In some embodiments, to enhance robustness and interpretability, a regularization term is added to the objective function. This term may be designed to maintain the observation weights in proximity to the normalized sample weights, which are adjusted to sum to one. In some embodiments, a tradeoff emerges between the goal of closely matching the desired bin frequencies and the objective of keeping the observation weights near the normalized sample weights. This tradeoff may be managed by applying a hyperparameter, lambda, which is greater than or equal to zero. In some embodiments, the value of lambda is selected by the user to achieve robust and credible results. For the implementation of regularization, the matrix C and the vector d are augmented with N additional rows. This augmentation can be represented as

$$d\_augmented = [ d ; lambda * w ] ;$$

$$C\_augmented = [ C ; lambda * speye ( N ) ] ;$$

Here, ‘d_augmented’ and ‘C_augmented’ are the augmented vector and matrix, respectively, that include the regularization term, and ‘speye(N)’ denotes the N-by-N identity matrix scaled by lambda.

In some embodiments, an alternative method for determining the optimum observation weights may involve the use of inequality constraints for each of the J desired target bin frequencies. In some embodiments, these constraints may be defined such that the upper limit is set at the target bin frequency plus a tolerance (d+tol), and the lower limit is set at the target bin frequency minus a tolerance (d−tol). Consequently, the reweighted percentages for the specified bins may be constrained to fall within a range of plus or minus the tolerance around the target bin frequency (d). This may ensure that the reweighted data adheres closely to the desired distribution while allowing for a controlled degree of variation to accommodate uncertainties or variations in the data.

### Use Case 1—Marketing Model Deployment Across Geographies

Consider the case of a marketer who has previously developed a response model based on consumer data from Geography A. This marketer has preserved detailed model development data, which includes consumer-level records with predictive features and a binary response/non-response label (i.e., dependent variables) from a past marketing campaign in Geography A. The marketer now intends to deploy the existing model to target new consumers in a different Geography B. Although the marketer has not collected data records for consumers in B, they possess knowledge from other data sources, such as publicly available demographic data, or from their own experience, indicating that the population in B tends to be older, less wealthy, and less educated compared to the population in A. Consequently, the model's predictive performance in A, which might be assessed by a Lift Chart on the development sample, is not expected to be indicative of its performance in B. Therefore, the marketer seeks an estimate of the model's expected predictive power when applied to consumers in B to ensure its effectiveness before launching an expensive marketing campaign in B.

The approach described herein addresses this challenge by reweighting the model development data records from population A so that the reweighted distribution aligns with the marketer's understanding of consumers in B. With this approach, the marketer can now utilize the reweighted data sample to evaluate the expected model performance in B, for instance, by creating a new Lift Chart based on the reweighted data. In fact, any model performance assessment method that accommodates a sample weight variable, such as ROC analysis, the Kolmogorov-Smirnov measure, Gini measure, misclassification error, type-I and type-II errors, and business measures of model benefit (including expected revenue, cost, loss, profit, ROI, etc.), can be applied to the reweighted sample. This allows for the assessment of expected model performance measures when the model is applied to the population in B, prior to the actual deployment of the model for B.

### Use Case 2—Wellness Service Provider and Economic Change

Consider a wellness service provider that employs a prescriptive machine learning model to generate various personalized wellness offers. These offers may be influenced by factors such as individuals' discretionary incomes and hours spent at work. Five years ago, a vendor developed the model using data collected by the provider during a period of economic prosperity. Since then, the original model development dataset may have been deleted. Two years ago, when the economy was still robust, the provider may have gathered new data for the purpose of model assessment and retained this assessment data. Presently, the provider is anticipating a future recession that could lead to a decrease in discretionary income and work hours. Consequently, the provider is seeking to understand how such a recession might impact the volume of offers made.

The provider has formulated expectations regarding how an impending recession would likely cause a downward shift in the distributions of discretionary incomes and work hours. The approach presented here caters to this analytical demand by reweighting the two-year-old assessment sample in a manner that incorporates the provider's domain expertise. This reweighting is designed to mirror the anticipated shifts in data distribution for variables such as ‘discretionary income’ and ‘hours spent at work.’ Leveraging the approach, the provider can subsequently evaluate the model's projected future offer volumes using the reweighted sample.

### Use Case 3—Enhancing Model Robustness in High-Risk Scenarios

Consider the scenario where a data scientist is tasked with developing a new predictive machine learning model for a sensitive, high-risk application. It is imperative that the model is not just accurate, but also robust and secure against potential threats from outside attackers. These attackers might attempt to input intentionally distorted data into the model, aiming to generate erroneous predictions that could compromise or disrupt dependent processes.

The systems and methods described herein may provide the data scientists with the tools to simulate a broad spectrum of potential attack scenarios by creating thousands or even millions of distorted data samples. This may allow for a comprehensive assessment of how the model might respond to such attacks. In some embodiment, data scientists may analyze the effects of these distorted predictions on various processes for each simulated scenario. Gaining such insights may enable data scientists to reinforce the model's defenses against such attacks before the model is deployed in a real-world environment.

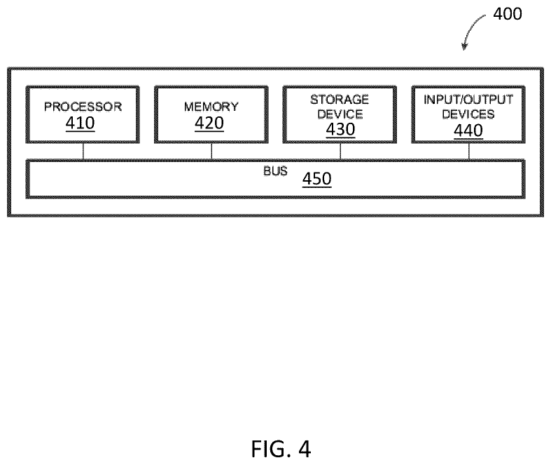

FIG. 4 depicts a block diagram illustrating a computing system 400 consistent with implementations of the current subject matter. As shown in FIG. 4, the computing system 400 can include a processor 410, a memory 420, a storage device 430, and input/output devices 440. The processor 410, the memory 420, the storage device 430, and the input/output devices 440 can be interconnected via a system bus 450. The computing system 400 may additionally or alternatively include a graphic processing unit (GPU), such as for image processing, and/or an associated memory for the GPU. The GPU and/or the associated memory for the GPU may be interconnected via the system bus 450 with the processor 410, the memory 420, the storage device 430, and the input/output devices 440. The memory associated with the GPU may store one or more images described herein, and the GPU may process one or more of the images described herein. The GPU may be coupled to and/or form a part of the processor 410. The processor 410 is capable of processing instructions for execution within the computing system 400. Such executed instructions can implement one or more components. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 440. The user interface can be generated and presented to a user by the computing system 400 (e.g., on a computer screen monitor, etc.).

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method, the method comprising:
maintaining a historical data sample comprising a plurality of observation records, each observation record comprising a set of predictive features, a set of dependent variables, and a baseline weight variable;
binning the plurality of observation records across the set of predictive features and the set of dependent variables to generate predictive feature bins and dependent variable bins,
generating a target distribution for the plurality of observation records, wherein the target distribution comprises a first plurality of target bin percentages for a subset of the predictive feature bins and a second plurality of target bin percentages for a subset of the dependent variable bins;
generating a reweight variable for each of the observation records based at least in part on the target distribution and the baseline weight variable, and
generating a reweighted data sample by replacing the baseline weight variable in each observation record of the historical data sample with a corresponding reweight variable.

2. The method of claim 1, wherein each of the observation records further comprises a set of non-predictive variables, and wherein the set of non-predicative variables is binned to generate non-predicative variable bins.

3. The method of claim 1, further comprising feeding the reweighted data sample to a classifier and training the classifier by the reweighted data sample.

4. The method of claim 1, further comprising assessing a performance of a pre-existing machine learning model by the reweighted data sample.

5. The method of claim 1, wherein generating the reweight variable comprises optimizing an objective function by minimizing a difference between the reweight variable and the baseline weight variable.

6. The method of claim 5, wherein the optimizing the objective function is conditioned on a deviation between the target distribution and an achieved distribution does not exceed a pre-defined tolerance.

7. The method of claim 1, wherein generating the reweight variable comprises optimizing an objective function by minimizing deviations between the target bin percentages and corresponding resultant bin percentages in the reweighted data sample.

8. A system, comprising
at least one programmable processor; and
a non-transient machine-readable medium storing instructions that, when executed by the processor, cause the at least one programmable processor to perform operations comprising:
maintaining a historical data sample comprising a plurality of observation records, each observation record comprising a set of predictive features, a set of dependent variables, and a baseline weight variable;
binning the plurality of observation records across the set of predictive features and the set of dependent variables to generate predictive feature bins and dependent variable bins,
generating a target distribution for the plurality of observation records, wherein the target distribution comprises a first plurality of target bin percentages for a subset of the predictive feature bins and a second plurality of target bin percentages for a subset of the dependent variable bins;
generating a reweight variable for each of the observation records based at least in part on the target distribution and the baseline weight variable, and
generating a reweighted data sample by replacing the baseline weight variable in each observation record of the historical data sample with a corresponding reweight variable.

9. The system of claim 8, wherein each of the observation records further comprises a set of non-predictive variables, and wherein the set of non-predicative variables is binned to generate non-predicative variable bins.

10. The system of claim 8, wherein the operations further comprise feeding the reweighted data sample to a classifier and training the classifier by the reweighted data sample.

11. The system of claim 8, wherein the operations further comprise assessing a performance of a pre-existing machine learning model by the reweighted data sample.

12. The system of claim 8, wherein generating the reweight variable comprises optimizing an objective function by minimizing a difference between the reweight variable and the baseline weight variable.

13. The system of claim 12, wherein the optimizing the objective function is conditioned on a deviation between the target distribution and an achieved distribution does not exceed a pre-defined tolerance.

14. The system of claim 8, wherein generating the reweight variable comprises optimizing an objective function by minimizing deviations between the target bin percentages and corresponding resultant bin percentages in the reweighted data sample.

15. A computer program product comprising a non-transient machine-readable medium storing instructions that, when executed by at least one programmable processor, cause the at least one programmable processor to perform operations comprising:
maintaining a historical data sample comprising a plurality of observation records, each observation record comprising a set of predictive features, a set of dependent variables, and a baseline weight variable;
binning the plurality of observation records across the set of predictive features and the set of dependent variables to generate predictive feature bins and dependent variable bins,
generating a target distribution for the plurality of observation records, wherein the target distribution comprises a first plurality of target bin percentages for a subset of the predictive feature bins and a second plurality of target bin percentages for a subset of the dependent variable bins;
generating a reweight variable for each of the observation records based at least in part on the target distribution and the baseline weight variable, and
generating a reweighted data sample by replacing the baseline weight variable in each observation record of the historical data sample with a corresponding reweight variable.

16. The computer program product of claim 15, wherein each of the observation records further comprises a set of non-predictive variables, and wherein the set of non-predicative variables is binned to generate non-predicative variable bins.

17. The computer program product of claim 15, wherein the operations further comprise feeding the reweighted data sample to a classifier and training the classifier by the reweighted data sample.

18. The computer program product of claim 15, wherein the operations further comprise assessing a performance of a pre-existing machine learning model by the reweighted data sample.

19. The computer program product of claim 15, wherein generating the reweight variable comprises optimizing an objective function by minimizing a difference between the reweight variable and the baseline weight variable.

20. The computer program product of claim 19, wherein the optimizing the objective function is conditioned on a deviation between the target distribution and an achieved distribution does not exceed a pre-defined tolerance.
